(19) United States
(12) Patent Application Publication
(10) Pub. No.: US 2007/0121510 A1
(43) Pub. Date: May 31, 2007

(54) Methods and apparatus for designing traffic distribution on a multiple-service packetized network using multicommodity flows and well-linked terminals

(76) Inventors: Chandra S. Chekuri, Chatham, NJ (US); Sanjeev Khanna, Philadelphia, PA (US); Frederick Bruce Shepard, Summit, NJ (US)

Correspondence Address: Ryan, Mason & Lewis, LLP, Suite 205, 1300 Post Road, Fairfield, CT, 06824, US

(21) Appl. No.: 11/287,890

(22) Filed: Nov. 28, 2005

(51) Int. Cl. H04J 1/16; H04L 12/56

(52) U.S. Cl. 370/235; 370/400

(57) ABSTRACT

Methods and apparatus are provided for designing traffic distribution in a multiple-service packetized network using such multicommodity flows and well-linked terminals. Arbitrary multicommodity flows f̅ are transformed to sets of well-linked terminals. The multicommodity flows are represented in a graph G having a set of k node-pairs s₁t₁, . . . ,sₖtₖ, each having a positive integer demand dᵢ and a positive weight wᵢ. The graph G is partitioned into a collection of node-disjoint subgraphs wherein each sub-graph H contains a set of terminals, where \vec{π} is a non-negative weight function on a set X of nodes in the graph G; and then the set of terminals are clustered to a subset of terminals that is at least ¼-flow-linked or ¼-cut-linked.

### STATEMENT OF GOVERNMENT RIGHTS

This invention was made with Government support from the Office of Naval Research and under NSF Career Award CCR-0093117 awarded by the National Science Foundation. The Government may have certain rights in this invention.

### FIELD OF THE INVENTION

The present invention relates generally to “traffic engineering” techniques that distribute traffic among permissible routes, and more particularly, to “traffic engineering” techniques that are based on multicommodity flows and well-linked terminals.

### BACKGROUND OF THE INVENTION

Communication networks transport information between terminal communication devices, such as computer terminals, telephones, facsimile machines, and computer file servers. A typical network includes switching nodes, interconnected by links. Generally, each terminal device is associated with one of the nodes. In many modern networks, the information to be transported from a source node to a destination node is divided into packets or cells. At each node encountered along the way, a packet is typically directed into an appropriate available link based on header information contained in the packet.

Many communications are sensitive to the timing of the packet arrivals at the destination. If there are significant absolute or relative delays, or if the packets arrive out of order, the quality of the call may become unacceptable. To preserve the quality of such communications, it is desirable to maintain a complete route from the source to the destination for the entire duration of the transaction.

In most networks, more than one route will generally be available between a given source and a given destination. It is not always desirable, however, to make available every potential route between a given source-destination pair. For example, some routes may pass through an excessive number of links that will add an unacceptable cumulative delay. In addition, each link has a limited amount of bandwidth.

A number of “traffic engineering” techniques have been proposed or suggested to distribute traffic among permissible routes, for example, based on a desired level of network performance. Traffic engineering problems are further complicated in the presence of multiple classes of service, such as voice, video, fax, and e-mail transmissions, on the same network. Each service has its own requirements for bandwidth and acceptable delay. A network that carries more than one class of service is often referred to as a “multiservice network.”

One approach to traffic engineering in multiservice networks is described in U.S. Pat. No. 6,721,270, to Mitra et al., entitled “Multicommodity Flow Method for Designing Traffic Distribution on a Multiple-Service Packetized Network,” assigned to the assignee of the present invention. The Mitra patent discloses a traffic design method based on concepts relating to multicommodity flow.

One class of traffic engineering techniques attempts to maximize the throughput across available source-destination pairs. For example, the traffic engineering techniques can maximize the number of source-destination pairs that can be satisfied, or the profits of source-destination pairs that can be satisfied. A source-destination pair is said to be satisfied if all of the demand associated with the source-destination pair is routed. According to an “all-or-nothing” multicommodity flow, the demand is potentially routed along many paths between the source-destination pairs. See, e.g., C. Chekuri et al., “The All-Or-Nothing Multicommodity Flow Problem,” Proc. of STOC (June, 2004), incorporated by reference herein. According to an “unsplittable flow,” a single path must be used to route the demand between the source-destination pair. See, e.g., C. Chekuri et al., “Edge Disjoint Paths in Unidirected Planar Graphs,” Proc. of FOCS (November 2004), incorporated by reference herein.

It is also known to apply a multicommodity flow relaxation that allows partial demands to be routed between source-destination pairs. The multicommodity flow relaxation provides an upper bound on the number of source-destination pairs that can be routed. While such currently available traffic engineering techniques effectively maximize the throughput across available source-destination pairs, they suffer from a number of limitations, which, if overcome, could further improve the efficiency and utility of traffic engineering techniques. For example, the notion of well-linked decomposition was previously limited to edge capacitated problems. A need therefore exists for an extension of the notion of well-linked instances to node capacitated problems. A further need exists for methods and apparatus for designing traffic distribution in a multiple-service packetized network using such multicommodity flows and well-linked terminals.

### SUMMARY OF THE INVENTION

Generally, methods and apparatus are provided for designing traffic distribution in a multiple-service packetized network using such multicommodity flows and well-linked terminals. According to one aspect of the invention, arbitrary multicommodity flows f̅ are transformed to sets of well-linked terminals. The multicommodity flows are represented in a graph G having a set of k node-pairs s₁t₁, . . . ,sₖtₖ, each having a positive integer demand dᵢ and a positive weight wᵢ. The graph G is partitioned into a collection of node-disjoint subgraphs wherein each sub-graph H contains a set of terminals, where \vec{π} is a non-negative weight function on a set X of nodes in the graph G; and then the set of terminals are clustered to a subset of terminals that is at least ¼-flow-linked or ¼-cut-linked.

The partitioning can be based on computing sparse cuts in the graph, G and can generate a node-induced subgraph partition of H into H₁,H₂, . . . with associated weight functions \vec{π}₁,\vec{π}₂, . . . For an edge problem, the clustering step is based on a subset X′⊂X such that X′ is ½-flow-linked in G and |X′|=Ω(\vec{π}(X)) if X is \vec{π}-flow-linked in G. For a node problem, the clustering step is based on a subset X′⊂X such that X′ is ¼-flow-linked in G and |X′|=Ω(\vec{π}(X)) if X is \vec{π}-flow-linked in G, for a node problem.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary capacitated graph G=(V, E) upon which the algorithms of the present invention can operate;

FIG. 2 is a flow chart describing an exemplary well-linked terminal process 200 incorporating features of the present invention

FIG. 3 is a flow chart describing an exemplary decomposition algorithm incorporating features of the present invention, that is employed by the well-linked terminal process of FIG. 2;

FIG. 4 is a flow chart describing an exemplary clustering process incorporating features of the present invention, that is employed by the well-linked terminal process of FIG. 2; and

FIG. 5 is a block diagram of a well-linked terminal processing system that can implement the processes of the present invention.

### DETAILED DESCRIPTION

The present invention provides multicommodity flow, well-linked terminals methods and apparatus for designing traffic distribution on a multiple-service packetized network. Consider several fundamental multicommodity routing problems in both edge and node capacitated undirected graphs. FIG. 1 illustrates an exemplary capacitated graph G=(V, E) upon which the algorithms of the present invention can operate. As shown in FIG. 1, the capacitated graph G has n nodes and m edges, and a set of k node-pairs s₁t₁, . . . ,sₖtₖ, each with a positive integer demand dᵢ and a positive weight wᵢ. The sᵢ's and tᵢ's are referred to herein as terminals and that are assumed to be distinct. The objective is to find a largest (or maximum w-weight) routable subset S of {1, 2, . . . , k}, that is, the pairs in S can be simultaneously satisfied obeying the capacity of the graph. The various problems are distinguished by the different constraints (edge capacities, integer routings) placed on the feasibility of a routing.

One important problem is the disjoint path problem. Here, each pair has di=l and a set S is routable if G contains edge (node) disjoint paths Pᵢ, i∈S, such that Pᵢ joins sᵢ and tᵢ. When pairs have different integer demands dᵢ and each pair has to be routed on a single path, the “unsplittable flow problem” is encountered: a set S is routable if G contains paths Pᵢ, i∈S, such that Pᵢ joins sᵢ and tᵢ and dᵢ flow can be routed on each Pᵢ without violating the edge (node) capacities. In the all-or-nothing flow problem, a set S is routable if there exists a multicommodity flow in G such that, for each i∈S, dᵢ flow is routed for pair sᵢtᵢ.

Recently, a poly-logarithmic upper bound was obtained on the integrality gap for the edge disjoint path problem planar graphs with congestion 2. See, C. Chekuri et al., “Edge Disjoint Paths in Unidirected Planar Graphs,” Proc. of FOCS, (2004). Chekuri et al. used a decomposition of the given instance into well-linked instances. The notion of well-linked instances can be formulated either based on a cut or flow requirement. Generally, an instance is cut-well-linked if the terminal set X={s₁. t₁, s₂,t₂, . . . , sₖ,tₖ} cannot be separated by small edge cuts. Note that this is a surprisingly strong property since the given instance is interested in only routing the k specified pairs, while well-linkedness of the terminal set requires satisfying the cut condition for routability of any matching on X.

According to one aspect of the invention, the notion of well-linked instances is extended for node capacitated problems that could not previously be obtained. First, it has been shown that oblivious routing for node-capacitated graphs requires a congestion of Ω(\sqrt{n}) even in planar graphs. This rules out a poly-logarithmic bound for a well-linked decomposition using prior approaches. Further, the maximum degree plays an important role in node problems. In the context of routing problems, this can be seen by the fact that for edge problems, the given graph can be transformed to a bounded degree graph (even preserving planarity), while there is no such reduction for node capacitated problems. Well-linked decompositions are obtained for node capacitated problems using a different approach.

According to another aspect of the invention, a new algorithm is disclosed that produces a “well-linked decomposition” from a given multicommodity flow in edge-capacitated or node-capacitated undirected graphs. The notion of a well-linked decomposition is precise, and in particular, a weighted (or fractional) version of well-linkedness is introduced that facilitates the transformation of the original multicommodity flow. Producing a well-linked set is less straightforward in the node case. Flow-well-linked and cut-well-linked decompositions are distinguished. These two notions are approximately equivalent on any graph G, separated only by the product multicommodity max flow-min cut gap in G. However, one or the other is preferable based on the application in question.

The following results are obtained using the disclosed decomposition algorithm and several other ideas. In the following, k is used to refer to the number of pairs in the given routing problems instance. All approximation bounds stated below are derived by measuring performance against an optimal LP solution with no congestion. It is noted that the value of an optimum solution to the flow LP (for either edge or node problems) increases only by a factor of B when congestion of B is allowed. It then follows that whenever an a-approximation is obtained using a congestion of B, it is also a (Ba)-approximation with respect to the optimal solution that is allowed a congestion of B. As used herein, B will be a small constant and its impact on the approximation ratio is not explicitly stated. When working with basic solutions to the LP, attention is restricted to the case when k≦m and hence in the bounds below, log k is O(log n).
For the edge capacitated all-or-nothing flow problem, an O(log² k) approximation is obtained in general graphs and an O(log k) approximation is obtained in planar graphs. These improve upon earlier ratios of O(log³ n log log n) and O(log² nlog log n).
For the edge disjoint path problem in planar graphs, an O(log k) approximation is obtained with congestion 2. This improves the prior O(log² n log logn) approximation.
For the node-capacitated all-or-nothing flow problem, a first poly-logarithmic approximation is obtained with congestion (1+∈) for any fixed ∈>O. A ratio O(log² k) is obtained for general graphs and O(log k ) for planar graphs.
For the node disjoint path problem in planar graphs, an O(log k) approximation is obtained with congestion 4.

Preliminaries

A. Input Instances

When considering an edge (node) routing problem, a given capacitated graph G=(V,E,c) is used where c is an integer capacity function on edges (nodes) if we are. Let n=|V| and m=|E|. Throughout, for any graph G and proper node subset S⊂V, δ_{G}(S), or simply δ(S) if G is clear from the context, denotes the set of edges of G with exactly one endpoint in S. N(S) denotes the set of nodes in V\S that are adjacent to some nodes in S. An instance of a routing problem consists of a capacitated graph G=(V,E,c) and a collections of pairs T={s₁t₁,s₂t₂, . . . ,sₖtₖ}. Nodes in T are referred to as terminals. Each occurrence of a terminal u that participates in p pairs is replaced by new terminals v₁, v₂, . . . , vₚ that are each connected to v by a unit capacity edge. There is a clear one-to-one correspondence between routings in the original and the modified instances. Thus, without loss of generality, it can be assumed that each terminal has degree 1 and the pairs in T form a perfect matching on the terminals. As shown below, attention can be restricted to instances in which all capacities are polynomially bounded; this in turn allows any routing problem to be reduced to a unit capacity instance.

B. Multicommodity Flow LP Formulation

For the given instance with T={s₁t₁,s₂t₂, . . . , sₖtₖ}, Pᵢ denotes the paths joining sᵢ and tᵢ in G and let P=UᵢPᵢ. The following multicommodity flow relaxation is used to obtain an upper bound on the number of pairs from T that can be routed in G. For each path P∈P, a variable f(P) is the amount of flow sent on P. xᵢ denotes the total flow sent on paths for pair i. | f̅| denotes the flow vector with a component for each path P, and | f̅| denotes the value Σᵢxᵢ. Then, the LP relaxation problems is the following.

$$\begin{matrix}\begin{matrix}max {\sum }_{i = 1}^{k} {x}_{i} & s . t\end{matrix} \\ \begin{matrix}{x}_{i} - {\sum }_{P ∈ Pi} f ( P ) = 0 & 1 \leq i \leq k\end{matrix} \\ \begin{matrix}{\sum }_{P : e ∈ P} f ( P ) \leq c ( e ) & ∀ e ∈ E\end{matrix} \\ \begin{matrix}{x}_{i} , f ( P ) ∈ [ 0 , 1 ] & 1 \leq i \leq k , P ∈ P\end{matrix}\end{matrix}$$

For node problems, the capacity constraint is replaced by Σ_{P:v∈P}f(P)≦c(v) ∀v∈V. OPT denotes the optimum solution value to the above relaxation. A path P is fractionally routed if f(P)∈(0,1), otherwise f(P)∈{0,1} and P is integrally routed. If the total flow routed on integrally routed paths is more than OPT/2, then a 2-approximation is obtained for all versions of the routing problem considered here. Thus, the interesting and difficult case is when the fractionally routed paths contribute almost all the value of OPT. From standard polyhedral theory, the number of fractionally routed paths in a basic solution to the edge (node) LP above is at most m (n). Therefore, it can be assumed that c(e)≦m for all edges and c(v)≦n for all nodes. By making parallel copies of edges, in the following, it is assumed that G has only unit capacity edges. For node problems, G can be transformed and it can be assumed that the node capacities are 1, however the transformation does not preserve planarity.

C. Product Multicommodity Flow, Concurrent Flow and Sparse Cuts

A multicommodity flow instance in a capacitated graph G=(V, E, c) is given by a demand vector d that assigns to each pair uv of nodes a non-negative value. A product multicommodity flow is a special case where d is induced by a weight function w:V→R⁺ on the nodes of V: for uv, d(uu)=w(u)w(v). Given a multicommodity flow instance, there are two quantities of interest. The maximum concurrent flow for the given instance is the largest λ such that λ_{d} can be feasibly routed in G. The sparsity of a cut is the ratio of the capacity of the cut to the demand separated by the cut, and a sparsest cut is one that achieves the maximum sparsity among all cuts. It can be checked that the minimum sparsity is an upper bound on the maximum concurrent flow, however, the former could be strictly larger. The maxflow-mincut gap is the worst case ratio between these two quantities. For product multicommodity flows, this gap is at most O(log k) in general graphs for both the edge and node cases where k is the number of commodities (non-zero d(uv) entries ). In planar graphs and graphs excluding fixed minors, for the edge case, the gap is O(1). Given a weight function on the nodes w:V→R⁺, the minimum quotient cut is a cut that minimizes the ratio of the capacity of the cut to the node weight of the smaller side in the partition produced by the cut. The sparsity of the product multicommodity flow instance induced by w is within a factor of two of the minimum quotient cut value for w. Approximation algorithms for computing sparsest cuts and minimum quotient cuts can be obtained via flow-cut gaps or via other methods that can give better bounds than the flow-cut gap.

Flow and Cut Well-linked Sets

Consider two notions of well-linked sets, one based on flows and another based on cuts. The disclosed algorithms work with fractional versions of these concepts. These terms are defined for both edge and node problems.

Given a non-negative weight function \vec{π}:X→R⁺ on a set X of nodes, X is \vec{π}-flow-linked in G if there is a feasible multicommodity flow (node or edge-capacitated accordingly) for the problem with demand \vec{π}(u)\vec{π}(v)/\vec{π}(X) between every unordered pair of terminals u, v∈X. Note that this is a product multicommodity flow with w(u)=\vec{π}(u)/\sqrt{\vec{π}(X)}. For an edge problem, a set X is \vec{π}-cut-linked in G if |δ(S)|≧\vec{π}(S∩X) for all S such that \vec{π}(S∩X)≦\vec{π}(X)/2. For a node problem, a set X is \vec{π}-node-cut-linked (or \vec{π}-cut-linked if the context is clear) in G if |N(S)|≧\vec{π}(S∩X) for all S such that \vec{π}(S∩X)≦\vec{π}(X)/2, where N(S) is the set of nodes in V\S that are adjacent to a node in S. When the context is clear, a reference to the edge or node problems is not explicitly included. It can be checked easily that if a set X is \vec{π}-flow-linked in G, then it is \vec{π}-cut-linked. The converse relationship is weaker; if X is \vec{π}-cut-linked, then it is \vec{π}/β-flow-linked where β is the worst-case mincut-maxflow gap on product multicommodity instances on G.

It is sometimes useful to work with “uniformly” linked instances. To this end, if the function \vec{π}(u)=α for all u∈X, X is a-flow(or cut)-linked. Note that 1-cut-linked sets have been well-studied and are also called well-linked. A set of terminals is referred to as being “well-linked” if it is c-flow-linked or c-cut-linked for some global constant c (not specified ahead of time).

The importance of such linked instances is that they form “fractional” crossbars with low congestion for their terminals. This is captured by the following.

PROPOSITION 1.2. Given a subset X⊂V of nodes that is a-flow-linked in G, any matching on X can be fractionally routed with congestion 2/α.

In the following discussion, when working with well-linked sets, it is implicitly assumed that the weight of any node is at most 1.

### Multicommodity Flows to Sets of Well-Linked Terminals

Using Proposition 1.2, if a set of terminals X is α-flow-linked, then Ω(α|X|) flow can be routed for any matching on X. This section presents algorithms incorporating features of the present invention that establish a converse relationship: given an arbitrary multicommodity flow vector f̅ for a routing problem, a collection of well-linked terminal sets of weight Ω(| f̅|/poly log(n)) can be recovered from them.

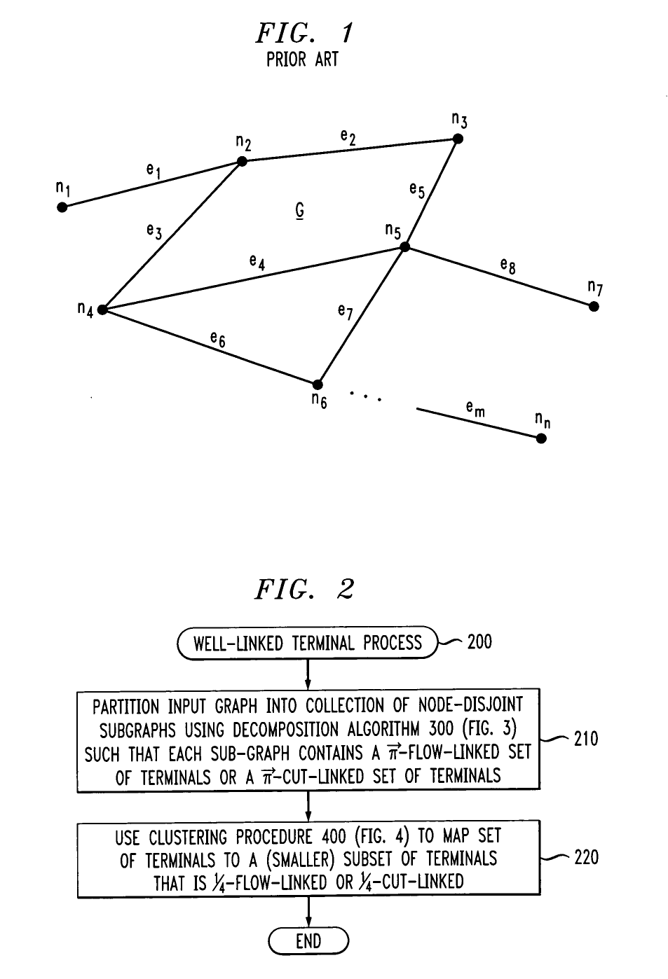

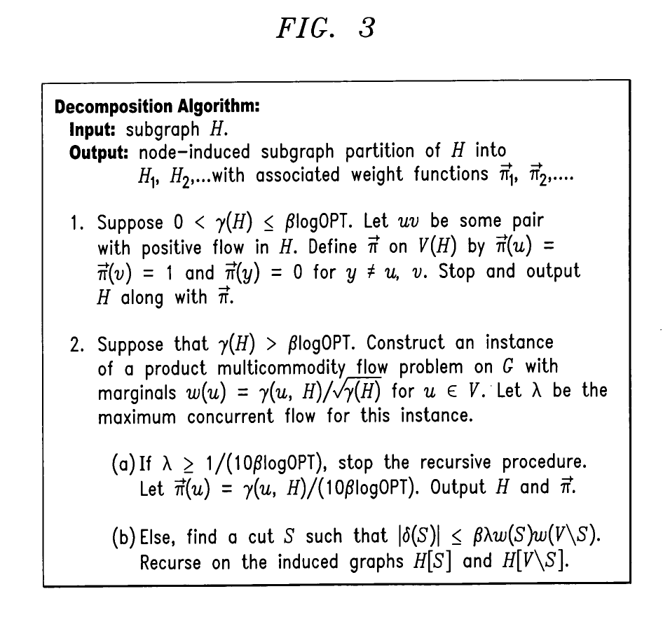

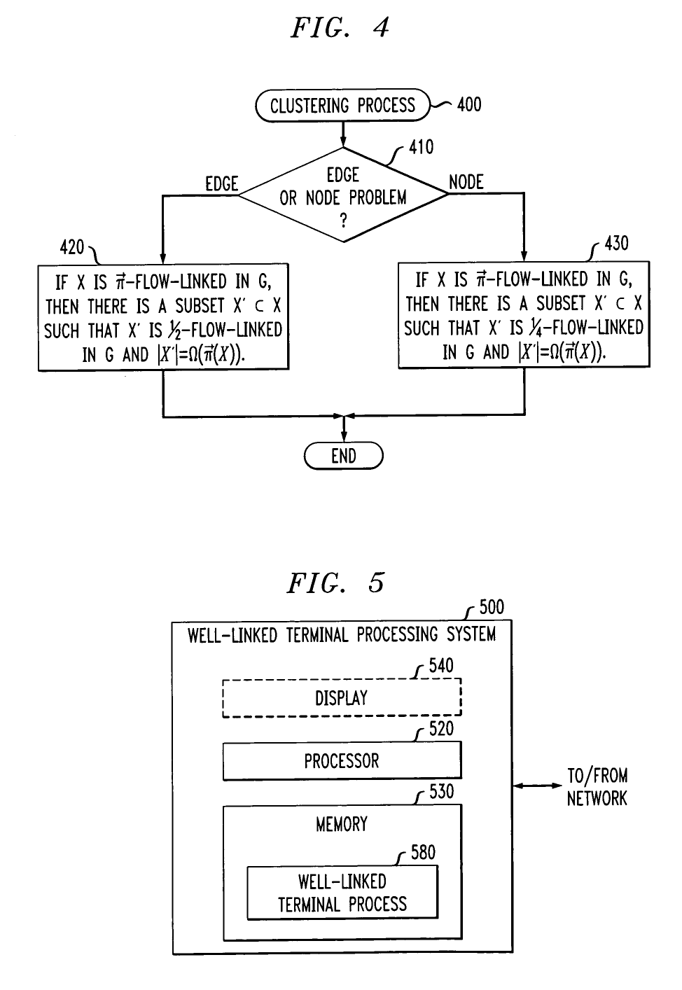

FIG. 2 is a flow chart describing an exemplary well-linked terminal process 200 incorporating features of the present invention. As shown in FIG. 2, the well-linked terminal process 200 transforms multicommodity flows to sets of well-linked terminals in two steps. The first step 210 of the transformation is to partition the input graph into a collection of node-disjoint subgraphs such that each sub-graph contains a \vec{π}-flow-linked set of terminals or a \vec{π}-cut-linked set of terminals, using a decomposition algorithm 300 discussed further below in conjunction with FIG. 3. The second step 220 of the transformation uses a clustering procedure 400 (discussed further below in conjunction with FIG. 4) that maps a \vec{π}-flow-linked set of terminals to a (smaller) subset of terminals that is ¼-flow-linked. In the following discussion, algorithms are first presented for converting arbitrary flows to \vec{π}-flow-linked terminals using a decomposition algorithm 300 (FIG. 3) during step 210, and then it is shown how to recover Ω(1)-flow-linked terminals from them during step 220 using a clustering process 400 (FIG. 4).

Multicommodity Flows to \vec{π}-Flow-Linked Terminals

A transformation is first presented for creating a collection of flow-linked sets. As previously indicated, the well-linked terminal process 200 partitions the input graph into a collection of node-disjoint subgraphs during step 210, such that each sub-graph contains a \vec{π}-flow-linked set of terminals or a \vec{π}-cut-linked set of terminals. Another similar decomposition for cut-linked sets is discussed at the end of this section.

Theorem 2.1. Let OPT be a solution to the LP for a given instance (G,T) of EDP (NDP) in a graph G. Let β(G)≧1 be an upper bound on the worst case mincut-maxflow gap for edge (node) product multicommodity flow problems in G. Then, there is a partition of G into node-disjoint induced subgraphs G₁,G₂, . . . ,Gₗ and weight function \vec{π}:V(Gᵢ)→R⁺ with the following properties. Let Tᵢ be the induced pairs of T in Gᵢ and let Xᵢ be the set of terminals of Tᵢ.

$$\begin{matrix}1. & {\vec{π}}_{i} ( U ) = {\vec{π}}_{i} ( v ) for uv ∈ {T}_{i} . \\ 2. & {X}_{i} is \vec{π} \text{-} flow \text{-} linked in {G}_{i} . \\ 3. & {\sum }_{i = 1}^{l} {\vec{π}}_{i} ( {X}_{i} ) = Ω ( OPT / ( β ( G ) log OPT ) ) .\end{matrix}$$

Moreover, such a partition is computable in polynomial time if there is a polynomial time algorithm for computing a cut of value β(G) times the maxflow.

β is used as a shortcut for β(G). A recursive partitioning scheme is described for constructing the sets Xᵢ and graphs Gᵢ. Let OPT denote the value of starting flow and hence it is fixed in the procedure below.

FIG. 3 is a flow chart describing an exemplary decomposition algorithm 300 incorporating features of the present invention, that is employed by the well-linked terminal process 200 during step 210. The decomposition algorithm 300 has the desired properties of Theorem 2.1. The first two properties in Theorem 2.1 can be checked as they are enforced in the two terminating steps (Steps 1 and 2a of FIG. 3).

The partitioning procedure naturally defines a recursion tree. The leaves of the tree are the graphs where the recursion is stopped either because the flow is sufficiently small or the concurrent flow for the product multicommodity flow is large enough. Let G₁,G₂, . . . ,Gₗ be the subgraphs produced by the decomposition. From the terminating conditions it follows that \vec{π}(Gᵢ)≧γ(Gᵢ)/(10βlog OPT). Thus, it is sufficient that

$${\sum }_{i = 1}^{l} γ ( {G}_{i} ) \geq γ ( G ) / 2.$$

Instead, it can be shown that the flow lost in all the recursive steps is at most γ(G)/2. The flow lost is upper bounded by the total number of edges that are cut in the partitioning process.

For edge problems, β(G)=O(log k) for general graphs and β(G)=O(1) for planar graphs. For node problems, β(G)=O(log k) for general graphs and for planar graphs, it is shown herein that the gap is O (1) (see Theorem 4.4) a similar decomposition also works to obtain cut-linked sets, based on the approximation ratio for the minimum quotient cut.

Theorum 2.3. Let OPT be a solution to the LP for a given instance (G,T) of EDP (NDP) in a graph G. Let β(G)≧1 be an upper bound on the approximation ratio of a polynomial time algorithm for the minimum quotient edge (node) cut problem in G. Then, there is a polynomial time algorithm that partitions G into node-disjoint induced Gⱼ, G₂, . . . , Gₗ and to each Gᵢ assigns a weight function \vec{π}: V(Gᵢ)→R⁺ with the following properties. Let τᵢ be the induced pairs of τ in Gᵢ and let Xᵢ be the set of terminals of τᵢ.

$$\begin{matrix}1. & {\vec{π}}_{i} ( u ) = {\vec{π}}_{i} ( v ) for uv ∈ {τ}_{i} . \\ 2. & {X}_{i} is {\vec{π}}_{i} \text{-} cut \text{-} linked in {G}_{i} . \\ 3. & {\sum }_{i = 1}^{l} \vec{π} ( {X}_{i} ) = Ω ( OPT / ( β ( G ) log OPT ) ) .\end{matrix}$$

For general graphs β(G)=O(log k), which has been improved to O(\sqrt{log n}) for the edge case and extended to the node case. For planar graphs β(G)=O(1) for both edge and node case.

\vec{π}Flow-Linked to Well-Linked Terminals

The main idea underlying this transformation is to consolidate terminals into connected clusters such that each cluster has Ω(1) units of flow originating from it. One of the terminals in a cluster can be chosen as its representative. This idea has been used where an arbitrary rooted spanning tree of the graph was chosen and the tree partitioned into edge-disjoint subgraphs of \vec{π}-weight Θ(1) each in a bottom-up manner.

FIG. 4 is a flow chart describing an exemplary clustering process 400 incorporating features of the present invention, that is employed by the well-linked terminal process 200 during step 220. As shown in FIG. 4, a test is first performed during step 410 to determine if an edge or a node problem is being considered. If it is determined during step 410 that an edge problem is being considered, then the following theorem is applied during step 420:

Theorem: 2.5a. If X is \vec{π}-flow-linked in G, then there is a subset X′⊂X such that X′ is ½-flow-linked in G and |X′|=Ω(\vec{π}(X)).

If, however, it is determined during step 410 that a node problem is being considered, then the following theorem is applied during step 430:

Theorem: 2.5b. If X is \vec{π}-flow-linked in G, then there is a subset X′⊂X such that X′ is ¼-flow-linked in G and |X′|=Ω(\vec{π}(X)).

But the clustering scheme for node problems turns out to be somewhat more difficult than for edge problems in that the degree of the nodes in the forest plays an important role. In the edge case, the partitioning of the tree implicitly uses the reduction to the bounded degree case. The following two lemmas are needed that establish existence of low degree spanning forests where each tree contains sufficiently large weight. Node problems do not normally start with a \vec{π}-flow-linked set, but rather use a uniformly linked set, as is guaranteed by Remark 2.4. Thus, in the following it is assumed that there are α-node-flow-linked sets.

In a further variation of the invention, an alternative clustering process for the node problem can be executed during step 430. The alternative clustering process applies to both flow-linked and cut-linked cases. As discussed more fully below, a set of nodes X in an undirected graph G=(V,E) is node-well-linked if for all S⊂V,|N_{G}(S)|≧min {|S∩X|,|X|−|S∩X|}. Here, N_{G}(S) is the set of neighbors of S in V\S. Given a weight function π: X→[0,1], X is a π-node-well-linked set X if for all S,|N_{G}(S)≧min {π(S∩X),π(X)−π(S∩X)}. Given a π-node-well-linked set X, a polynomial time algorithm is disclosed to find a set X′⊂X such that X′ is ¼-node-well-linked and |X′|=Ω(π(X)). Further, if given a perfect matching M on X with π(u)=π(v) for each uv∈M, M induces a perfect matching M′ on X′. Similar results are provided for the notion of flow-well-linkedness. These results improve previous algorithms for node-capacitated routing problems obtained via well-linked decompositions.

Consider the problem of well-linked sets in node-capacitated undirected graphs. Given a graph G=(V, E) and a subset S∈V of nodes, N_{G}(S) (or simply N(S)) denotes the neighbors of S: formally a node v∈N(S) if there is a node u∈S such that uv∈E and u∈V\S. A set of nodes X⊂V is node-well-linked (or simply well-linked) if for all S⊂V,|N(S)|≧min{|S∩X|,|X|−|S∩X|}. Equivalently, X is well-linked if for all subsets Y,Z of X with |Y|=|Z| and Y∩Z=φ there are |Y| node-disjoint Y-Z paths. The notion of well-linked sets is closely tied to that of treewidth and plays a central role in the work of Robertson and Seymour on graph minors. The treewidth of a graph G and the cardinality of the largest well-linked set in G are within a small constant factor of each other. A weighted version of well-linkedness is employed herein. Given a set in X and weight function if π:X→[0,1] X is π-well-linked if for all S⊂V,|N(S)|≧min{π(S∩X),π(X)−π(S∩X)}. If π is uniform on X, that is there is some a such that π(u)=α for all u∈S then X is α-well-linked. Thus, X is well-linked if X is 1-well-linked.

A relation notion of flow-well-linkedness is also employed herein. Let X⊂Vπ:X→[0,1]. Consider a multicommodity flow matrix D_{π} induced on X as follows: D(uv)=π(u)π(v)/π(X) if u,v∈X and 0 otherwise. X is π-flow-well-linked (or π-flow-linked for short) if D_{π} is routable in G with node capacities 1. It can be observed that if X is π-flow-linked then X is π/2-well-linked, however the converse relationship is weaker. It can be shown that if X is π-well-linked then X is π/β(G,|X|)-flow-linked where β(G,k) is the flow-cut gap for node capacitated product multicommodity flow problems in G on k nodes. For general graphs it is known that β(G,K)=O(log k) and for graphs that exclude a minor of size r it is known that β(G,K)=O(r²). It is noted that given X and π, it can be checked in polynomial time whether X is π-flow-well-linked while it is NP-hard to check if X is π-well-linked.

Theorem 3.1 Let X be a π-flow-linked set in G and let M be a perfect matching on X such that π(u)=π(v) for all uv∈M. Then, there is a matching M′⊂X with end points X′⊂X such that X′ is ¼-flow-linked in G and |M|=2|X′|=Ω(π(X)). Further, M′ and X′ can be found in polynomial time. The same holds for well-linked sets.

In Theorem 3.1, a promise is required that X is π-well-linked since checking it is NP-hard. A similar theorem has been shown for the edge capacitated case using a simple clustering scheme, however the node capacitated case is non-trivial and only a weak version was known before. Theorem 3.1 allows improved approximation algorithms to be obtained of routing problems such as disjoint paths, all-or-nothing flow and unsplittable flow in node-capacitated graphs using the framework described herein. The main implications are the following.
An O(log²n) approximation for the node-capacitated all-or-nothing flow problem with congestion 1+∈.
An O(log n) approximation for node-disjoint paths in planar graphs with congestion 2.

Theorems on Single Source Flow

A. Incremental Augmentation of Directed Flow

Let G=(V ,A,c) be a directed graph with integer arc capacities given by c. For S⊂V, the set of arcs (u,v), such that u∈V\S, is denoted by δ_{G}(S), or simply δ(S) if G is clear from the context. Let s₁, s₂, . . . , sₖ be distinct nodes (terminals) that demand to send flow to a sink node t. A non-negative vector (b_{1,}b₂, . . . , bₖ) is a feasible flow vector if the terminals can route Σᵢbᵢ flow to t with bᵢ flow originating at sᵢ for 1≦i≦k. Let B be the set of all feasible flow vectors. For a vector b∈B, let F(b)=Σᵢbᵢ denote the total flow. For b∈B, let I(b) be the index set of terminals that have integer flow, that is, i∈B, let F(b)=Σᵢbᵢ denote the total flow. For b∈B, let I(b) be the index set of terminals that have integer flow, that is, i∈I(b) iff bᵢ is an integer.

Theorem 4.1 Given b∈B and j∉I(b) with bⱼ>0, b′∈B can be computed in polynomial time with b′ⱼ=|bⱼ| and F(b′)≧F(b) such that
b′ₗ≦┌bₗ┐ for 1≦l≦k, and
b′ᵢ=bᵢ, for i∈I(b).

B. Routing Flow to Node Separators

Let G=(V ,E) be a undirected graph with unit node capacities. Let w:V→[0,1] define non-negative weights on V. A partition of V into A, B, C such that (i) A,B≠φ and (ii) there are no edges between A and C, is called a separation with B as the node separator. Note that C is allowed to be empty which implies that B need not be a proper separator, however, it is defined this way for convenience of notation.

Theorem 4.2 Let G be a connected graph with w:V→[0,1] and w(V)>1. Given α∈(1,w(V)), there is A, B, C separation in G that can be computed in polynomial time such that
w(A∪B)>α,
   |B|=└w(A∪B)/α┘, and
each node u∈A∪B can send w(u)/α flow simultaneously to B where each node in B has capacity 1.

The above theorem is inspired by the proof of the relationship between grid minors and treewidth in planar graphs given by Robertson, Seymour and Thomas, “Quickly Excluding a Planar Graph,” J. of Combinatorial Theory (B), 62: 323-348 (1994).

Theorem 3.1 is proved in two steps. In the first step, a set Y⊂V is identified such that |Y|=Ω(π(X)) such that terminals in X can send flow to Y with the following conditions: a) the amount of flow received by a node in Y is 1 and b) a node u in X sends at most π(u) flow. This shows that Y is ½-flow-linked. In the second step, Y is used to pick a sub-matching M′ of M and its end points X′ such that |X′|=Ω(|Y|) and such that X′ can be connected to Y by node disjoint paths. This will show that X′ is Ω(1)-flow-linked. The algorithm remains the same for the well-linked case and the proofs are very similar.

First Step: A weight function w is set up on V as follows: set w(v)=π(v) if v∈X and w(v)=0 if v∉X. It follows that for any set A⊂V, w(A)=π(A∩X) and that V is w-node-flow-linked. Theorem 2.2 is applied on w with α=4 to obtain an A, B, C separation with the property that |B|=└s(A∪B)/4┘ and such that each node u∈A∪B can send w(u)/4 flow to B. Since V is w-node-flow-linked, it follows that w(A∪B)>w(V)/2. In fact, w(A∪B)≧4w(V)/5 and hence |B|≧w(V)/4. The set B is the desired Y.

Proposition 5.1 The set Y is ½-flow-linked.

Second Step: Let Z be the set of terminals that send flow to Y identified in the first step. The set Z corresponds to the terminals in the set A∪B, hence, π(Z)≧4π(X)/5. Therefore, there is a matching M′⊂M such that the end points of M′ are contained in X′ and π(M′)≧3π(M)/5. The goal is now to find a matching M″⊂M′ of size Ω(|Y|) such that X″ the end points of M″ can be connected to Y by disjoint paths. Instead, ½ disjoint paths are obtained, as follows.

Let X′ be the end points of M′. X′ is partitioned into X₁ and X₂ such that for each pair uv∈M′ exactly one of u, v is in each X₁,X₂. Two copies are created of G, G₁ and G₂. Pick X′₁⊂X′₁ and X′₂⊂X′₂ such that for each u∈X′₁, its mate v is picked in X′₂. Further X′₁ and X′₂ each can route to Y using disjoint paths in G₁ and G₂ respectively and |X′₁|=|X′₂|=Ω(|Y|). This is accomplished using incremental flow-augmentation suggested by Theorem 4.1. Note that Theorem 4.1 applies to node-capacitated routing using the standard reduction of node-capacitated single source flows to the directed edge capacitated case. In G₁ a new sink node t₁ is added and each node to Y is connected to t₁. Similarly, a sink node t₂ is added in G₂, each node to Y is connected to t₂. From construction of Y, each node u∈X′ can send a flow π(u)/4 to Y. Thus, a single source flow problem in G₁ is obtained with nodes in X₁ sending flow to t₁. Similarly, nodes in X₂ send flow to t₂ in G₂. Arbitrary pair is picked uv∈M′. Say u∈G₁ and v∈G₂. Theorem 4.1 is applied and the flow is augmented from u to t₁ to a value of 1 in G₁. The flow of from u to t₂ is augmented to 1 in G₂. The pair uv is frozen and will their flow is not altered in future iterations. u is added to X′₁ and v to X′₂. At the end of this step, flows for other nodes might have changed in G₁ and G₂. For a pair xy∈M′ with x∈X′₁ and y∈X′₂ let fₓ and f_{y} the flows left and let f=min{fₓ,f_{y}}. The flow of both x and y are reduced to f in G₁ and G₂ respectively. This is done for all remaining pairs. The total reduction of flow over all pairs is bounded by 1. This follows from the property guaranteed by Theorem 4.1. In augmenting flow of u to 1 in G₁ at most 1 unit of flow is decreased to other nodes. Similarly, in G₂ and hence the total decrease is bounded by 2. This is charged to uv. In the next iteration, another pair is picked with non-zero flow and augment their flow to 1 and so on. Let X″=X′₁∪X′₂ and let M″ be the matching induced on them. From the above discussion it follows |M″|=2|X″|=Ω(π(X′)).

Proposition 5.2 The set X″ is ¼-flow-linked.

For the well-linked case the algorithm proceeds as above.

While the exemplary processes shown in FIGS. 2 through 4 provide an example of a sequence of steps, it is also an embodiment of the present invention that the sequence may be varied. Various permutations of the algorithm are contemplated as alternate embodiments of the invention.

FIG. 5 is a block diagram of a Well-Linked Terminal Processing System 500 that can implement the processes of the present invention. As shown in FIG. 5, memory 530 configures the processor 520 to implement the well-linked terminal methods, steps, and functions disclosed herein (collectively, shown as 580 in FIG. 5). The memory 530 could be distributed or local and the processor 520 could be distributed or singular. The memory 530 could be implemented as an electrical, magnetic or optical memory, or any combination of these or other types of storage devices. It should be noted that each distributed processor that makes up processor 520 generally contains its own addressable memory space. It should also be noted that some or all of computer system 500 can be incorporated into an application-specific or general- use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, , memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for transforming arbitrary multicommodity flows f̅ to sets of well-linked terminals, wherein said multicommodity flows are represented in a graph G having a set of k node-pairs site s₁t₁, . . . ,sₖtₖ, each having a positive integer demand dᵢ and a positive weight w_{i.} said method comprising:
partitioning said graph G into a collection of node-disjoint subgraphs wherein each sub-graph H contains a set of terminals, where \vec{π} is a non-negative weight function on a set X of nodes in said graph G; and
clustering said set of terminals to a subset of terminals that is at least ¼-flow-linked or ¼-cut-linked.

2. The method of claim 1, wherein said partitioning step is based on computing sparse cuts in said graph, G.

3. The method of claim 1, wherein said partitioning step generates a node-induced subgraph partition of H into H₁e,H₂, . . . with associated weight functions \vec{π}₁,\vec{π}₂, . . . .

4. The method of claim 1, wherein said partitioning step further comprises the steps of (i) constructing an instance of a product multicommodity flow problem on G with marginals w(u)γ(u,H)/\sqrt{γ(H)} for u∈V, when γ(H)>βlog OPT, where λ is the maximum concurrent flow for this instance; and (ii) assigning \vec{π}(u)=γ(u,H)/(10βlog OPT) and stopping the recursive procedure if λ≧1/(10βlog OPT), or (iii) recursively finding a cut S wherein |δ(S)|≦βλw(S)w(V\S) on the induced graphs H[S] and H[V\S].

5. The method of claim 1, wherein said clustering step is based on a subset X′⊂X such that X′ is ½-flow-linked in G and |X′|=Ω(\vec{π}(X)) if X is \vec{π}-flow-linked in G, for an edge problem.

6. The method of claim 1, wherein said clustering step is based on a subset X′⊂X such that X′ is ¼-flow-linked in G and |X′|=Ω(\vec{π}(X)) if X is \vec{π}-flow-linked in G, for a node problem.

7. The method of claim 1, wherein said well-linked terminals are processed according to an “all-or-nothing” multicommodity flow.

8. The method of claim 1, wherein said well-linked terminals are processed according to an unsplittable flow.

9. An apparatus for transforming arbitrary multicommodity flows f̅ to sets of well-linked terminals, wherein said multicommodity flows are represented in a graph G having a set of k node-pairs s₁t₁, . . . ,sₖtₖ, each having a positive integer demand dᵢ and a positive weight w_{i.} said apparatus comprising:
a memory; and
at least one processor, coupled to the memory, operative to:
partition said graph G into a collection of node-disjoint subgraphs wherein each sub-graph H contains a set of terminals, where \vec{π} is a non-negative weight function on a set X of nodes in said graph G; and
cluster said set of terminals to a subset of terminals that is at least ¼-flow-linked or ¼-cut-linked.

10. The apparatus of claim 9, wherein said partitioning step is based on computing sparse cuts in said graph, G.

11. The apparatus of claim 9, wherein said partitioning step generates a node-induced subgraph partition of H into H₁,H₂, . . . with associated weight functions \vec{π}₁,\vec{π}₂, . . . .

12. The apparatus of claim 9, wherein said partitioning step further comprises the steps of (i) constructing an instance of a product multicommodity flow problem on G with marginals w(u)γ(u,H)/\sqrt{γ(H)} for u∈V, when γ(H)>βlog OPT, where λ is the maximum concurrent flow for this instance; and (ii) assigning \vec{π}(u)=γ(u,H)/(10βlog OPT) and stopping the recursive procedure if λ≧1/(10βlog OPT), or (iii) recursively finding a cut S wherein |δ(S)|≦βλw(S)w(V\S) on the induced graphs H[S] and H[V\S].

13. The apparatus of claim 9, wherein said clustering step is based on a subset X′⊂X such that X′ is ½-flow-linked in G and |X′|=Ω(\vec{π}(X)) if X is \vec{π}-flow-linked in G, for an edge problem.

14. The apparatus of claim 9, wherein said clustering step is based on a subset X′⊂X such that X′ is ¼-flow-linked in G and |X′|=Ω(\vec{π}(X)) if X is \vec{π}-flow-linked in G, for a node problem.

15. The apparatus of claim 9, wherein said well-linked terminals are processed according to an “all-or-nothing” multicommodity flow.

16. The apparatus of claim 9, wherein said well-linked terminals are processed according to an unsplittable flow.

17. An article of manufacture for transforming arbitrary multicommodity flows f̅ to sets of well-linked terminals, wherein said multicommodity flows are represented in a graph G having a set of k node-pairs s₁t₁, . . . ,sₖtₖ, each having a positive integer demand dᵢ and a positive weight w_{i.} comprising a machine readable medium containing one or more programs which when executed implement the steps of:
partitioning said graph G into a collection of node-disjoint subgraphs wherein each sub-graph H contains a set of terminals, where \vec{π} is a non-negative weight function on a set X of nodes in said graph G; and
clustering said set of terminals to a subset of terminals that is at least ¼-flow-linked or ¼-cut-linked.

18. The article of manufacture of claim 17, wherein said partitioning step is based on computing sparse cuts in said graph, G.

19. The article of manufacture of claim 17, wherein said well-linked terminals are processed according to an “all-or-nothing” multicommodity flow.

20. The article of manufacture of claim 17, wherein said well-linked terminals are processed according to an unsplittable flow.
